(19) United States
(12) Patent Application Publication
(10) Pub. No.: US 2001/0041453 A1
(43) Pub. Date: Nov. 15, 2001

(54) PROCESS FOR PATTERNING CONDUCTIVE LINE WITHOUT AFTER-CORROSION

(76) Inventor: MASAHIKO OHUCHI, TOKYO (JP)

Correspondence Address: NORMAN P SOLOWAY, HAYES SOLOWAY HENNESSEY, GROSSMAN & PAGE P C, 175 CANAL STREET, MANCHESTER, NH, 03101

(21) Appl. No.: 09/348,654

(22) Filed: Jul. 6, 1999

(30) Foreign Application Priority Data
Jul. 9, 1998 (JP) 10-193873

(51) Int. Cl. B08B 3/12

(52) U.S. Cl. 438/712; 438/706; 438/710; 438/714; 438/720; 438/734; 438/742; 134/1; 134/2; 134/3; 134/42

(57) ABSTRACT

An aluminum-copper alloy layer is patterned through a photo-lithography followed by a dry etching, and side walls of etching residue containing aluminum chloride, which is causative of after-corrosion in the aluminum-copper alloy line, is grown during the dry etching, wherein the side walls are exposed to gaseous mixture containing ionic water vapor so that hydrogen ion and/or the hydroxyl group reacts with the aluminum chloride, thereby converting the aluminum chloride to aluminum and/or aluminum hydroxide and hydrochloric acid vaporized into vacuum.

### FIELD OF THE INVENTION

This invention relates to a patterning technology used in a process for fabricating a semiconductor device and, more particularly, to a process for patterning conductive lines through a photo-lithography followed by an etching and an apparatus used in the process.

### DESCRIPTION OF THE RELATED ART

A multi-layered wiring structure is incorporated in a semiconductor integrated circuit device, and propagates electric signals between the circuits components. Various kinds of conductive material are available for the conductive lines. AlCu alloy is popular in manufacturers. A conductive line is implemented by a single layer of AlCu alloy, and another conductive line has a laminated structure containing an AlCu alloy layer. The AlCu alloy layer may form the laminated structure together with a Ti layer, a TiN layer, a TiW layer or a composite layer of TiN and Ti.

Those kinds of conductive material are usually deposited by using a sputtering technique and/or a chemical vapor deposition, and, thereafter, the conductive layer or layers are patterned into the conductive line through a photo-lithography followed by an etching. FIGS. 1A and 1B illustrate a typical example of the process for patterning a conductive layer into conductive lines.

A silicon substrate 1 is covered with an insulating layer 2. AlCu alloy is deposited over the entire surface of the insulating layer 2, and forms an AlCu alloy layer 3 on the insulating layer 2. Photo-resist solution is spread over the upper surface of the AlCu alloy layer 3, and is baked so as to form a photo-resist layer. A pattern image for conductive lines is transferred from a photo-mask to the photo-resist layer, and the latent image is formed in the photo-resist layer. The latent image is developed, and a photo-resist etching mask 4 is left on the AlCu alloy layer 3 as shown in FIG. 1A.

The resultant structure is placed in an etching chamber of a dry etching system (not shown), and the etching chamber is evacuated. Etching gas is introduced into the etching chamber, and contains boron trichloride expressed as BCl₃, chlorine or C12 and another kind of halogen containing gas such as CF₄ or CHF₃. The photo-resist etching mask 4 allows species produced from the etching gas to remove exposed portions of the AlCu alloy layer 3. As a result, the conductive lines 3a/3b/3c are formed from the AlCu alloy layer 3 as shown in FIG. 1B. Etching residue is deposited on the side surfaces of the conductive lines/photo-resist etching mask 3a/3b/3c/4 during the dry etching, and form side walls 5. The etching residue is a kind of mixture, which contains pieces of the photo-resist and reaction product between aluminum and chlorine such as, for example, AlCl₃.

Upon completion of the dry etching, the photo-resist is ashed in oxygen plasma, and the photo-resist etching mask 4 is removed from the resultant structure. However, the side walls 5 are partially left on the side surfaces of the conductive lines 3a/3b/3c.

Although the side walls 5 do not allow the species to taper the conductive lines 3a/3b/3c, the etching residue is causative of after-corrosion, i.e., a kind of aged deterioration of the conductive lines 3a/3b/3c due to corrosion after completion of the fabrication process. If the etching residue is left on the conductive lines 3a/3b/3c, the corrosion proceeds, and the conductive lines 3a/3b/3c tend to be disconnected and short-circuited. The corrosion proceeds through the following reaction formulae.

AlCl₃+3H₂O→Al(OH)₃+3 HCl

3 HCl+Al→3/2 H₂O+AlCl₃

The chlorine produces the etching residue, and, accordingly, the chloride is causative of the undesirable after-corrosion. However, the manufacturer can not remove the side walls 5 through the plasma ashing. For this reason, the manufacturer usually carries out an elimination of residual halogen such as chlorine. In the following description, a treatment against the after-corrosion is referred to as “anti-after-corrosion”.

The first prior art treatment for the anti-after-corrosion uses plasma produced from hydrogen atom containing gas, i.e., water vapor or alcohol vapor. The side walls 5 are exposed to the plasma, and the plasma eliminates the residual halogen from the resultant structure. However, the aluminum chloride is hardly removed from the side walls 5 or converted to another kind of compound which is not causative of the after-corrosion.

Thus, the prior art process contains the dry etching, the treatment for the anti-after-corrosion and the plasma ashing. The manufacturer carries out the treatment for the anti-after-corrosion and the plasma ashing either separately or concurrently. In other words, there are three combinations. In the first sequence, the treatment for the anti-after-corrosion is firstly carried out, and, thereafter, is followed by the plasma ashing. The second sequence is opposite to the first sequence, i.e., the plasma ashing is followed by the treatment for the anti-after-corrosion. In the third sequence, the treatment for the anti-after-corrosion and the plasma ashing are concurrently carried out.

The second prior art treatment for the anti-after-corrosion is exposure to water vapor after the plasma ashing. It is considered that the residual halogen is eliminated from the resultant structure through the following phenomenon.

However, there is a trade-off between the removal of the photo-resist etching mask 4 and the anti-after-corrosion effect in the prior art processes. In other words, if the prior art treatments for the anti-after-corrosion are carried out under the conditions to achieve good anti-after-corrosion effect, pieces of the photo-resist are liable to remain on the conductive lines 3a/3b/3c. On the other hand, if the plasma ashing is enhanced, the prior art treatments are less effective against the after-corrosion.

The trade-off is derived from change in quality of the photo-resist. The longer the anti-after-corrosion treatment, the higher the anti-after-corrosion effect. However, the plasma produced from the water vapor/alcohol merely achieves an extremely low ashing rate. In this situation, if the photo-resist etching mask is exposed to the plasma or the water vapor for a long time, the photo-resist is changed in quality, and is hardened. As a result, the photo-resist etching mask 4 is hardly ashed in the plasma, and pieces of photo-resist tend to be left on the conductive lines 3a/3b/3c. From this viewpoint, the second sequence and the second prior art treatment are more desirable than the first sequence. However, the halogen is confined in the side walls 5 during the plasma ashing, and are hardly eliminated from the side walls 5. This means that the halogen atoms remain in the side walls, and the conductive lines 3a/3b/3c are still left in the corrosive environment.

The third sequence is a compromise between the first sequence and the second sequence. However, the third sequence is less effective against the after-corrosion, and the photo-resist etching mask 4 is imperfectly removed. Another problem inherent in the third sequence is optimization of the process conditions. If the manufacturer prolongs the exposure to the plasma, the process conditions are biased to the anti-after-corrosion effect. However, an over-ashing takes place. On the other hand, if the manufacturer makes the process conditions restrict the over-ashing, the anti-after-corrosion effect is insufficient.

Thus, the anti-after-corrosion effect and the perfect removal of the photo-resist etching mask 4 are not compatible in the prior art processes.

### SUMMARY OF THE INVENTION

It is therefore an important object of the present invention to provide a patterning process, which is effective against the after-corrosion without difficulty in removal of a photo-resist mask.

It is also an important object of the present invention to provide an apparatus appropriate for the patterning process.

To accomplish the object, the present invention proposes to convert a halide to another compound not causative of the after-corrosion.

In accordance with one aspect of the present invention, there is provided a process for patterning a target layer, comprising the steps of a) preparing a semiconductor structure having the target layer covered with an etching mask formed of photo-resist, b) exposing the semiconductor structure to an etchant containing halogen so as to form the target layer into a pattern partially covered with unintentional layers of etching residue containing pieces of the photo-resist and halide, c) exposing the resultant structure of the step b) to gaseous mixture containing ionic water vapor where at least one of H⁺ and OH⁻ exists so that the halide reacts with the at least one of H⁺ and OH⁻, and d) ashing the photo-resist so as to remove the etching mask from the resultant structure of the step c).

In accordance with another aspect of the present invention, there is provided an apparatus for patterning a target layer comprising a partition wall defining a first chamber where a plasma generator, a wafer stage for mounting a semiconductor wafer and a temperature regulator for heating the semiconductor wafer on the wafer stage, a vacuum developer connected to the first chamber for creating vacuum in the first chamber, a vaporizer producing gaseous mixture containing ionic water vapor having at least one of H⁺ and OH⁻ and supplying the gaseous mixture to the first chamber, and a gas supplying system for supplying gas containing oxidizing component to the first chamber for a plasma ashing.

### BRIEF DESCRIPTION OF THE DRAWINGS

The features and advantages of the process and the apparatus will be more clearly understood from the following description taken in conjunction with the accompanying drawings in which:

FIGS. 1A and 1B are cross sectional views showing the prior art patterning process;

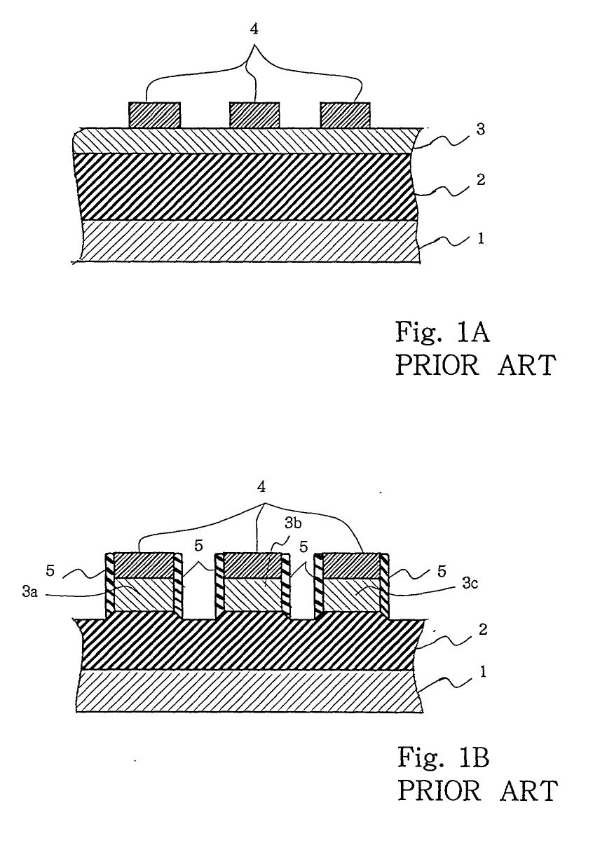

FIGS. 2A to 2D are cross sectional views showing a process for forming conductive lines according to the present invention;

FIGS. 3A and 3B are cross sectional views showing side walls left on a conductive line after a plasma ashing at a low ashing rate;

FIG. 4 is a graph showing the relation between a substrate temperature and an ashing rate;

FIG. 5 is a graph showing an appropriate temperature profile for a substrate;

FIG. 6 is a schematic plane view showing arrangement of chambers incorporated in an apparatus according to the present invention; and

FIG. 7 is a partially cut-away side view showing the inside of one of the chambers.

### DESCRIPTION OF THE PREFERRED EMBODIMENTS

Patterning Process

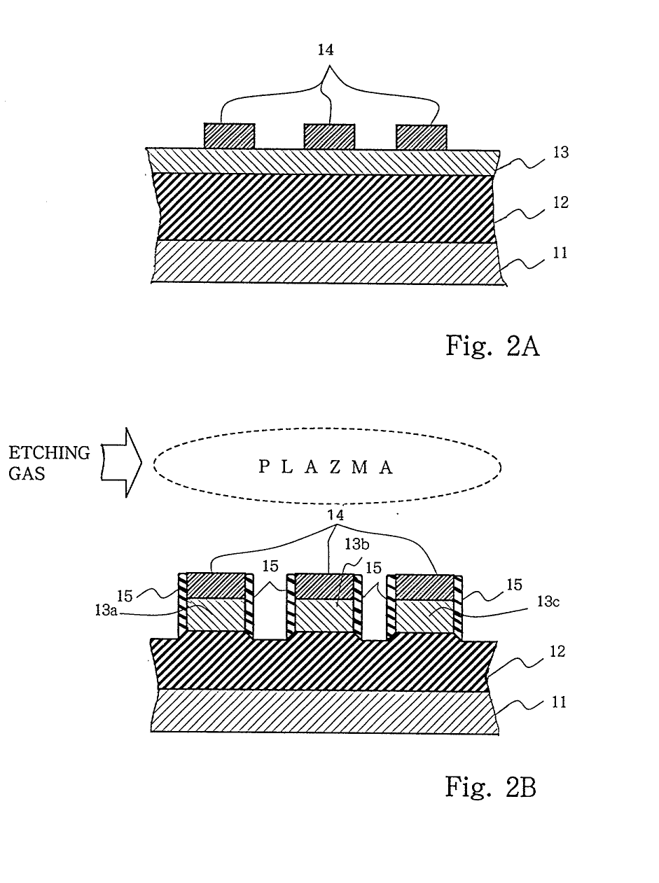

FIGS. 2A to 2D illustrate a process embodying the present invention. The process starts with preparation of a silicon wafer 11. Though not shown in the figures, circuit components such as, for example, transistors are fabricated on the silicon wafer 11. A kind of insulating material is deposited over the silicon wafer 11, and forms an inter-level insulating layer 12. The inter-level insulating layer 12 may be formed of silicon oxide. Aluminum-copper alloy is deposited over the entire surface of the inter-level insulating layer 12, and forms a conductive layer 13. The aluminum-copper alloy may be deposited by using a sputtering technique.

Subsequently, photo-resist solution is spread over the conductive layer 13, and is baked so as to cover the conductive layer 13 with a photo-resist layer. A pattern image for conductive lines is transferred from a photo-mask (not shown) to the photo-resist layer, and a latent image is formed in the photo-resist layer through the pattern transfer. The latent image is developed, and the photo-resist layer is formed into a photo-resist etching mask 14 as shown in FIG. 2A.

The resultant structure is placed in an etching chamber of a dry etching system (not shown). The air is evacuated from the etching chamber, and etching gas is introduced into the etching chamber. In this instance, the etching gas contains BCl₂ and Cl₂. The etching gas may further contain hydrofluorocarbon expressed as CH₄₋ₓFₓ.

The dry etching system produces plasma in the etching chamber, and exposed portions of the conductive layer 13 are etched away by the species produced from the etching gas. As a result, the conductive layer 13 is patterned into conductive lines 13a/13b/13c. While the species are selectively removing the conductive layer 13, etching residue is adhered to the side surfaces of the conductive lines/photo-resist etching mask 13a/13b/13c/14, and forms side walls 15 as shown in FIG. 2B. The etching residue contains pieces of the photo-resist and a kind of halide. In this instance, the etching gas contains chloride as the halogen, and the conductive layer 13 is formed of the aluminum-copper alloy. The chlorine reacts with the aluminum, and the halide is AlCl₃. As described in conjunction with the prior art process, the aluminum chloride is causative of the after-corrosion.

Subsequently, the resultant structure is heated in vacuum, and is exposed to gas containing ionic water. The ionic water vapor is produced by spraying ionic water, heating the ionic water or vaporized through ultra-sonic vibrations, and contains at least one of H⁺ and OH⁻. The vaporized ionic water penetrates into narrow gap between the side walls 15, and the side walls 15 are exposed to H⁺ and/or OH⁻. H⁺ and/or OH⁻ reacts with the aluminum chloride, and converts the aluminum chloride to aluminum or aluminum hydroxide as follows.

AlCl₃+H⁺→Al+HCl

AlCl₃+OH⁻Al(OH)₃+HCl

HCl is vaporized, and is removed from the side walls 15. HCl is finally evacuated from the vacuum chamber.

The ionic water may be sprayed to a kind of carrier gas so as to produce the water vapor containing hydrogen ion and hydroxyl group. Various kinds of heater are available for the ionic water vapor, and the vaporizer may be a part of a humidifier.

Although the side walls 5 are exposed to the plasma created from water or alcohol, the plasma does not convert the aluminum chloride to aluminum and/or the aluminum hydroxide.

Subsequently, the resultant structure is placed in an ashing chamber of a plasma ashing system. Vacuum is created in the ashing chamber, and oxidizing gas is supplied to the ashing chamber. The oxidizing gas may contain oxygen, ozone or gaseous mixture thereof. Any kind of oxidizing gas is available for the plasma ashing in so far as the oxidizing gas ashes the photo-resist. Plasma is produced in the ashing chamber, and the photo-resist etching mask 14 is ashed away as shown in FIG. 2D.

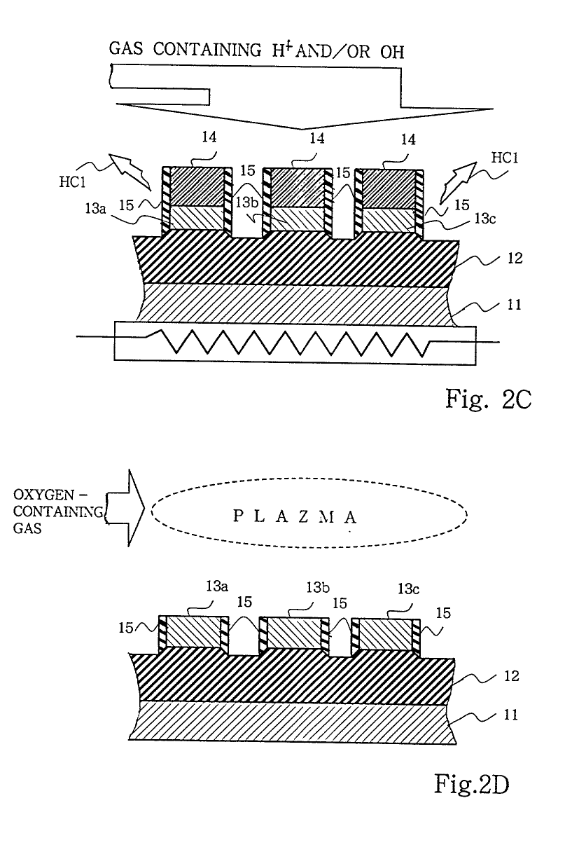

It is preferable to carry out the plasma ashing at a high ashing rate, because the oxygen plasma effectively removes the carbon contained in the photo-resist as CO or CO₂. If the ashing rate is low, the side walls 15 are left on the conductive line 13a/13b/13c upon completion of the plasma ashing as shown in FIG. 3A. The side walls 15 are liable to be broken, and the pieces of side walls 15 are left on the conductive line 13a/13b/13c as shown in FIG. 3B. The pieces of side walls 15 are causative of trouble in the conductive line 13a/13b/13c. On the other hand, when the ashing rate is high, the pieces of photo-resist in the wide walls 15 are ashed together with the photo-resist etching mask 14, and the side walls 15 are reduced. This results in that the conductive lines 13a/13b/13c are free from the trouble due to the pieces of side walls 15.

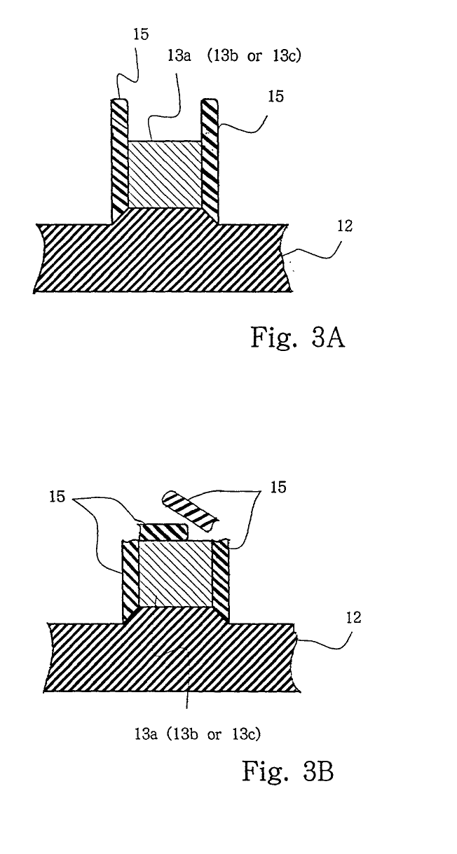

The present inventor investigated the ashing conditions for a high rate, and found that the substrate temperature strongly affected the ashing rate. The present inventor measured the ashing rate at different substrate temperature, and plotted the ashing rate in terms of the substrate temperature. FIG. 4 illustrates the relation between the substrate temperature and the ashing rate. The abscissa indicates the substrate temperature, and the axis of ordinates is indicative of the ashing rate. The scale for the ashing rate is arbitrary. When the substrate temperature was lowered around 170-180 degrees in centigrade, the ashing rate was drastically decreased. On the other hand, the photo-resist etching mask 14 was rapidly carbonized around 270 degrees in centigrade, and the ashing did not proceed. The present inventor concluded that the substrate temperature between 200-250 degrees made the ashing rate high.

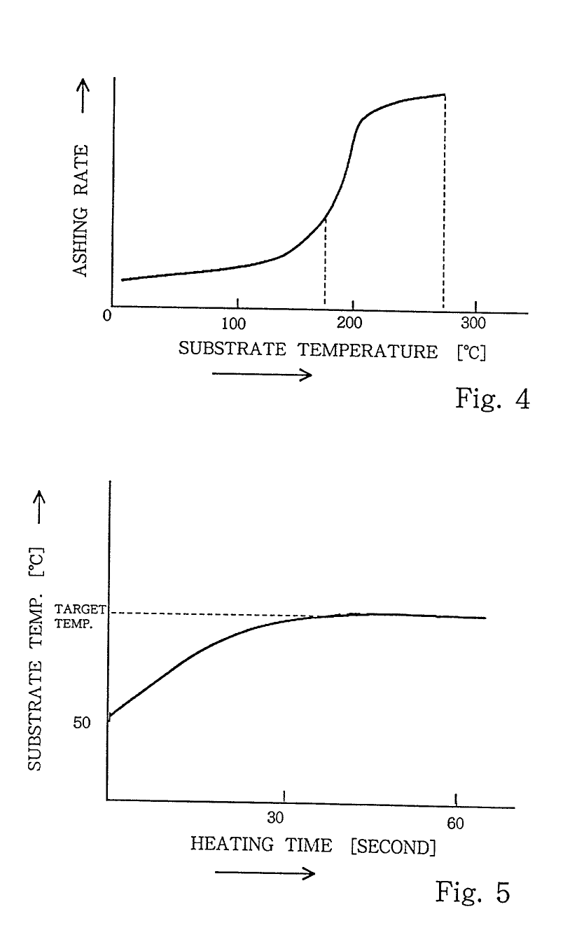

The present inventor further investigated a temperature profile for the anti-after-corrosion treatment and the plasma ashing, and found the appropriate temperature profile shown in FIG. 5. In detail, the resultant structure shown in FIG. 2B started to rise from an initial temperature such as, for example, 50 degrees in centigrade toward the target temperature between 200 degrees to 250 degrees in centigrade, and was exposed to the gas containing the ionic water vapor during the temperature rise from the initial temperature to the target temperature. The initial temperature preferably ranged from 50 degrees to 100 degrees in centigrade. The temperature gradient was regulated in such a manner that the resultant structure reached the target temperature between 30 seconds to 70 seconds. When the resultant structure reached the target temperature, the plasma ashing started, and the photo-resist etching mask 14 was removed through the ashing. The present inventor confirmed that the photo-resist etching mask 14 was perfectly ashed and that the exposure to the gas was effective against the after-corrosion.

The above-described process sequence is desirable, because the plasma ashing is continued to the treatment for the anti-after-corrosion without loss of time. This results in enhancement of the productivity.

The present inventor evaluated the process according to the present invention. First, aluminum-copper alloy was deposited, and the photo-resist etching mask 14 was formed on the aluminum-copper alloy layer 13. The aluminum-copper alloy was patterned through a dry etching under the following conditions.

Pressure in the etching chamber: 8 milli-torr

Substrate temperature: 40 degrees in centigrade

Etching gas: Cl₂/70 sccm, BCl₃/40 sccm, CHF₃/8 sccm

Source power: 1200 watts

Bias power: 130 watts

The etching chamber was maintained at 3 torr, and the ionic water vapor was supplied to the etching chamber at 750 sccm. While the ionic water vapor was being supplied to the etching chamber, the silicon wafer 11 is rising from 40 degrees in centigrade to 220 degrees in centigrade in the time period between 30 seconds to 70 seconds.

When the silicon wafer 11 reached 220 degrees in centigrade, the photo-resist etching mask 14 was ashed away under the following conditions.

Pressure in the etching chamber: 2 torr

Silicon wafer: 220 degrees in centigrade

Reactant gas: O₂/3000 sccm, N₂/200 sccm

Power of microwave: 1000 watts

After the ashing, the present inventor observed the conductive lines 13a/13b/13c through a microscope, and confirmed that the photo-resist etching mask 14 and the side walls 15 have been perfectly removed.

Subsequently, the conductive lines 13a/13b/13c were left in the atmosphere for a time period. The present inventor observed the conductive lines 13a/13b/13c through the microscope. However, the conductive lines 13a/13b/13c were not damaged due to the after-corrosion.

The present inventor completed a semiconductor device on the basis of the semiconductor wafer 11, and tested the semiconductor device. Any malfunction did not occur, and confirmed that the conductive lines 13a/13b/13c were never disconnected nor short-circuited.

As will be understood from the foregoing description, the gas containing the ionic water vapor effectively converts the aluminum halide to the aluminum and/or the aluminum hydroxide, and prevents the conductive lines 13a/13b/13c from the after-corrosion. The exposure to the gas does not affect the plasma ashing.

Apparatus

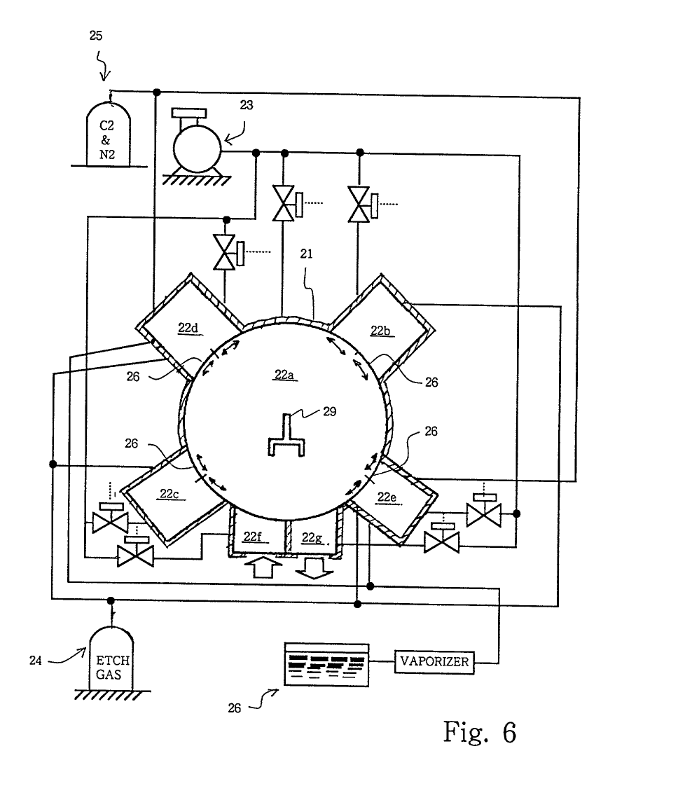

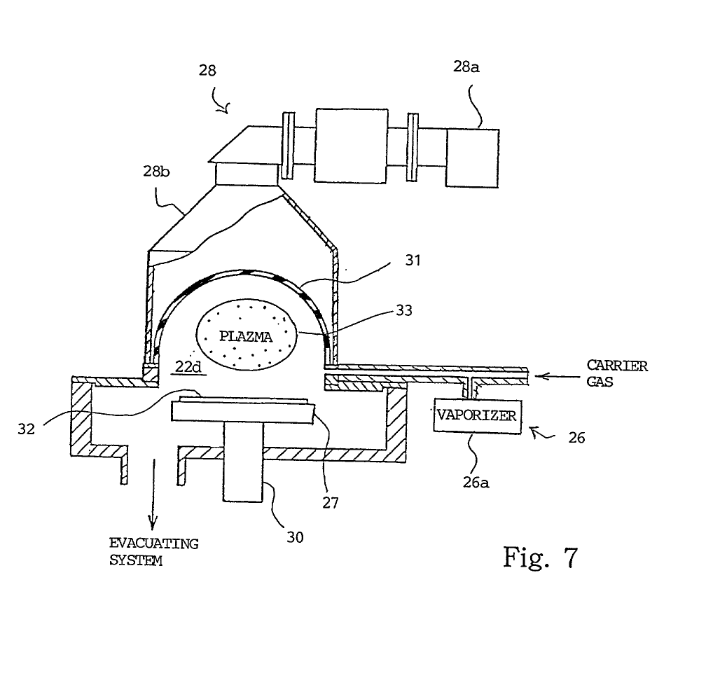

Turning to FIG. 6 of the drawings, an apparatus embodying the present invention has a partition wall 21, and the partition wall 21 defines a manipulating chamber 22a, process chambers 22b/22c/22d/22e, a load-lock chamber 22f and an unload-lock chamber 22g. The process chambers 22b/22c/22d/22e, the load-lock chamber 22f and the unload-lock chamber 22g are arranged around the manipulating chamber 22a. The apparatus further comprises an evacuating system 23, an etching gas supplying system 24, an ashing gas supplying system 25, an anti-after-corrosion treatment system 26, a heater/cooler 27 (see FIG. 7) and plasma generators 28 (see FIG. 7). Though not shown in the drawings, a flow-controller, a pressure controller and a temperature controller are respectively incorporated in the gas supplying systems 24/25, the evacuating system 23 and the heater/cooler 27, respectively.

A robot 29 is in the manipulating chamber 22a, and moves a wafer between the chambers 22b-22g. The load-lock chamber 22f separates the manipulating chamber 22a from the outside, and the wafer is supplied from the outside to the load-lock chamber 22f. The evacuating system 23 evacuates the air from the load-lock chamber 22f, and keeps the load-lock chamber 22f equal to the manipulating chamber 22a. The process chambers 22b to 22e are available for the dry etching, the anti-after-corrosion treatment and the ashing. In this instance, the process chambers 22b/22c are used for the dry etching, and the process chambers 22d/22e are assigned to the dry etching, the anti-after-corrosion treatment and the plasma ashing. The unload-lock chamber 22g also isolates the manipulating chamber 22a from the outside, and the wafer is transferred to the outside through the unload-lock chamber 22g. The air is introduced into the unload-lock chamber 22g before the transfer of the wafer to the outside, and, thereafter, the evacuating system 23 creates vacuum in the unload-lock chamber 22g.

When the wafer is transferred between the manipulating chamber 22a and the process chambers 22b-22e, the evacuating system 23 equalizes the vacuum in the manipulating chamber 22a to the vacuum in the process chambers 22b-22e, and the robot 29 conveys the wafer from the load-lock chamber 22f to the manipulating chamber 22a, from the manipulating chamber 22a to one of the process chambers 22b-22e, from the process chamber to another process chamber, from the process chamber to the manipulating chamber and from the manipulating chamber 22a to the unload-lock chamber 22g.

Turing to FIG. 7, the process chamber 22d/22e is closed with a quartz bell-jar 31, and is connected to the evacuating system 23, the etching gas supplying system 24 (not shown in FIG. 7), the ashing gas supplying system 25 (also not shown in FIG. 7) and the anti-after-corrosion treatment system 26. The plasma generator 28 has a magnetron 28a, and the magnetron 28a is connected to the process chamber 22d through a wave-guide 28b. Though not shown in FIG. 7, a solenoid is provided in association with the process chamber 22d, and creates a magnetic field, and a radio-frequency power source is further incorporated in the plasma generator 28. The wafer stage 30 is provided in the process chamber 22d, and a wafer 32 is placed on the wafer stage 30. The heater/cooler 27 is provided for the wafer 32, and controls the temperature of the wafer 32. The anti-after-corrosion treatment system 26 has a vaporizer 26a such as, for example, the ultra-sonic vibrator, and the ionic wafer is vaporized through the ultra-sonic vibrations. The plasma generator 28 creates plasma 33 in the process chamber, and the dry etching and the ashing are carried out by using the plasma generator 28.

The process chambers 22d/22e are available for the dry etching, the anti-after-corrosion treatment and the plasma ashing, and is appropriate to the process according to the present invention. The wafer is sequentially subjected to the dry etching, the anti-after-corrosion treatment and the plasma ashing in the process chamber 22d/22e, and the manufacturer improves the throughput by using the apparatus according to the present invention.

Although particular embodiments of the present invention have been shown and described, it will be apparent to those skilled in the art that various changes and modifications may be made without departing from the spirit and scope of the present invention.

The aluminum-copper alloy layer may be laminated with and/or on another kind of conductive layer such as, for example, a titanium layer, a titanium nitride layer or a titanium-tungsten layer.

In the above-described embodiment, the chloride containing etching gas is used in the dry etching. However, various kinds of etching gas are known, and are usually halogen-containing gases. Halogen elements produce halides, and the halides are also causative of the after-corrosion. For this reason, the present invention is never limited to the chlorine-containing etching gas and the aluminum-copper alloy.

What is claimed is:

1. A process for patterning a target layer, comprising the steps of:
a) preparing a semiconductor structure having said target layer covered with an etching mask formed of photo-resist;
b) exposing said semiconductor structure to an etchant containing halogen so as to form said target layer into a pattern partially covered with unintentional layers of etching residue containing pieces of said photo-resist and halide;
c) exposing the resultant structure of said step b) to gaseous mixture containing ionic water vapor where at least one of H⁺ and OH⁻ exists so that said halide reacts with said at least one of H⁺ and OH⁻; and
d) ashing said photo-resist so as to remove said etching mask from the resultant structure of said step c).

2. The process as set forth in claim 1, in which said etchant is an etching gas containing said halogen.

3. The process as set forth in claim 2, in which said halogen is chloride, and said target layer is formed of aluminum-copper alloy.

4. The process as set forth in claim 3, in which said etching residue contains aluminum chloride expressed as AlCl₃, and said at least one of H⁺ and OH⁻ reacts with said aluminum chloride through the reaction formulae expressed as
AlCl₃+H⁺→Al+HCl
AlCl₃+OH⁻Al(OH)₃+HCl

5. The process as set forth in claim 1, in which said ionic water vapor is produced by using a technique selected from the group consisting of spraying ionic water having at least one of H⁺ and OH⁻, heating said ionic water and vaporizing said ionic water through ultra-sonic vibrations.

6. The process as set forth in claim 3, in which said etching gas contains BCl₃ and Cl₂.

7. The process as set forth in claim 6, in which said etching gas further contains hydrofluorocarbon expressed as CH₄₋ₓFₓ.

8. The process as set forth in claim 1, in which said resultant structure is exposed to plasma produced from gas containing oxidizing component in said step d).

9. The process as set forth in claim 8, in which said oxidizing component is selected from the group consisting of oxygen, ozone and mixture containing oxygen and ozone.

10. The process as set forth in claim 8, in which said resultant structure is heated between 200 degrees in centigrade and 250 degrees in centigrade in said step d).

11. The process as set forth in claim 1, in which said resultant structure is heated from an initial temperature to a target temperature during the exposure to said gaseous mixture in said step c).

12. The process as set forth in claim 11, in which said step d) starts when said resultant structure reaches said target temperature.

13. The process as set forth in claim 11, in which said initial temperature and said target temperature respectively range from 50 degrees in centigrade to 100 degrees in centigrade and from 200 degrees in centigrade to 250 degrees in centigrade, and the time period from said initial temperature to said target temperature falls within the range between 30 seconds and 70 seconds.

14. An apparatus for patterning a target layer comprising:
a partition wall defining a first chamber where a plasma generator, a wafer stage for mounting a semiconductor wafer and a temperature regulator for heating said semiconductor wafer on said wafer stage;
a vacuum developer connected to said first chamber for creating vacuum in said first chamber;
a vaporizer producing gaseous mixture containing ionic water vapor having at least one of H⁺ and OH⁻ and supplying said gaseous mixture to said first chamber; and
a gas supplying system for supplying gas containing oxidizing component to said first chamber for a plasma ashing.

15. The apparatus as set forth in claim 14, in which said partition wall further defines a second chamber for loading said semiconductor wafer from the outside, a third chamber for unloading said semiconductor wafer to said outside and a fourth chamber connectable to said first chamber, said second chamber and said third chamber and having a manipulator for conveying said semiconductor wafer therebetween, 16. The apparatus as set forth in claim 15, further comprising another gas supplying system for supplying an etching gas to said first chamber.
